(19) United States
(12) Patent Application Publication
(10) Pub. No.: US 2023/0368701 A1
(43) Pub. Date: Nov. 16, 2023

(54) ADVANCED TRAINING SYSTEM MANNEQUIN SIMULATOR WITH CLEFT LIP AND PALATE

(71) Applicant: Teresa de Jesus Pannaci Padron, Barcelona (ES)

(72) Inventor: Teresa de Jesus Pannaci Padron, Barcelona (ES)

(73) Assignee: Teresa de Jesus Pannaci Padron, Barcelona (ES)

(21) Appl. No.: 18/123,262

(22) Filed: Mar. 18, 2023

Related U.S. Application Data
(60) Provisional application No. 63/342,116, filed on May 15, 2022.

(51) Int. Cl. G09B 23/28

(52) U.S. Cl. CPC G09B 23/283

(57) ABSTRACT

The present innovation relates to an Advanced Training System Mannequin Simulators of a complete newborn baby with facial and intraoral features of the CLP malformation, AMACS. It is intended for use in medical training of dental professionals, doctors, emergency medical support personnel and parents or caregivers. Furthermore, it can be adopted in several common therapies and in maneuvers such as intraoral impressions. It can also be used by any other person who requires a model simulator to learn the anatomy, practice procedures or surgery of the lip, nose and palate. The invention avoids unsettling a real newborn patient for training proposes. This mannequin simulator, as an innovative training resource, significantly shortens the learning curve of the trainees, since the procedures can be repeated over and over again. The AMACS comprises: (a) trunk and limbs, having as reference the weight and height of a real newborn, (b) a complete head (skull, face and neck), having as reference the facial and intraoral features of the CLP malformation, (c) the anatomy of the lips, nose, oral and nasal cavities with the actual dimensions and proportions of a newborn with CLP deformity. The most remarkable feature is a very accurate representation of the entire body but, in particular, the oral and facial anatomical features of a newborn with CLP deformity, thus allowing for a high-level and realistic training experience. In the facial and intraoral region of the mannequin the lips, tongue, cheeks, maxillary segments, palatal rugae, labial and lateral frenulum, nasal cavity, palate, hemi uvulae, tongue and lingual frenulum, columella, nostrils, alar cartilage, dome and nasal tip are faithfully reproduced. On the outer surface of the mannequin the skin, the route of the veins, the relief of the ribs and clavicles are also scrupulously represented. The mannequin may include the alteration of one or more anatomical parts to simulate the different types of congenital anomalies that affect the facial and intraoral region. One or more parts of the mannequin simulator may be disposable or replaceable. The careful design of the AMACS follows the process of: (a) computed tomography, scan, or photogrammetry images of the full skull and face of a human newborn with CLP; (b) generating the cleft lip and palate based on a three-dimensional reconstruction of the buccal area. The manufacture process involves methods independent and indispensable but not in sequence: (a) parts made by injection of polymer-based material; b) parts made by 3D printing, and (c) assembly. Both body and head are perfectioned using realistic painting techniques.

### CROSS-REFERENCE TO RELATED APPLICATIONS

This application claims priority to U.S. Provisional Patent Application No. 63/342,116 filed May 15, 2022. The foregoing applications are hereby incorporated by reference in their entirety.

### FEDERALLY SPONSORED RESEARCH OR DEVELOPMENT

Not applicable.

### TECHNICAL FIELD

The present disclosure pertains to medical training models, and in particular medical training mannequin models with cleft lip and palate (CLP), which thus generated are particularly realistic for training dental professionals, doctors and emergency medical support personnel. The present invention relates even more particularly to intraoral impression maneuver training, treatment planning, and various therapies and procedures common to patients with CLP, including manipulations, intraoral devices, nasal stents, and surgical tools. Additionally, the invention is related to training parents and caregivers of patients with CLP in daily oral hygiene, as well as in the proper handling, placement and removal of intraoral and nasal devices that these patients are required to wear at home.

### BACKGROUND

In the medical field, health professional education, learning activities are commonly based on patient cases. The procedures and maneuvers are learned by practicing on real patients (Thistlethwaite, 2012). The learning curve lengthens proportionally to the complexity of the procedure to be learned. Nevertheless, simulation training using mannequins and anatomical models instead of real patients, has been shown to be effective in linking theory and practice by professionals and are used to demonstrate, practice and assess clinical skills (Mahasneh et al., 2021).

To this day, human CLP new born patients are used for practicing procedures. Cleft lip and palate are the most common craniofacial malformations and the most difficult to manage (Yilmaz et al., 2019). Successful treatment of these children requires technical skill, in-depth knowledge of the abnormal anatomy, and appreciation of three-dimensional facial aesthetics. Due to the location and complexity of the malformations, vital functions of the newborn, such as breathing and swallowing, are compromised (Grabowski, 2006; Erantia, 2018). In its most common form, it is characterized by disruption of the lip, nostril sill, alveolus and palate. Both the palate and the lip are open, with a gap of 4-15 mm and this is associated with nasal deformity. The oral cavity and the nasal cavity are directly connected and the vital functions of the baby, such as breathing and feeding, are profoundly altered. Specialized care by responsible staff during the first hours after birth is crucial. To facilitate expected normal oral feeding by bottle or breast, a device should be created and applied as soon as possible after birth in order to internally cover the maxilla of the baby allowing effective feeding without the risk of choking.

To make this device, an intraoral impression of the maxilla must be taken from the patient a few hours after birth, and this is the crucial initial step (Pannaci, 2021). In fact, one of the most sensitive aspects is to teach how to take intraoral impressions of the neonates, due to the risk that this maneuver implies. Different methods for taking impressions have been reported in the literature of patients with CLP. The position of the patient, the selection of the sample holder and the impression material are important factors to consider while performing this procedure. Various positions of the child have been adopted for CLP impressions of infants or newborns, including: face down (Grayson et al, 2000), standing (Yang et al, 2003), face up (Jacobson, 1984) and even inverted face down (Grayson et al, 2005). The oral impression is taken when the child is fully awake without any anesthesia or premedication. Neonates need to be able to cry during the impression procedure, since absence of crying may indicate airway blockage.

The intraoral device is a prosthesis, known as pre-surgical plate, which is used 24/7 since the proper feeding and breathing of the newborn depends on it. Due to the rapid growth of neonates, these devices must be changed regularly (every 3-4 weeks). According to pre-surgical orthopedic treatment protocols, intraoral devices must be used as soon as possible after birth. This is the first step in order to allow the newborn to feed without relying on hospital care and, at the same time, the device prepares the patient for lip and palate surgery (Grayson et al., 1999; Brij esh, 2010; Goyal 2014; Pannaci, 2021).

As afore mentioned, to fabricate the intraoral device, it is necessary to take an impression of the oral cavity of the newborn patient. This is a maneuver that carries several risks, including blocking the passage of air through the nose and mouth with consequences that could endanger the life of the infant. Devices must be worn as pre-surgical treatment, in order to help the patient to feed properly and also to improve skeletal relationships and to increase the chances of success of the surgery (Alzain, 2017). Additionally, CLP parents and caregivers need to be properly trained in performing oral hygiene and in the correct feeding of newborns with the devices.

Nasal deformities are associated with CLP. To correct the malposition of the nasal cartilages there are also established protocols (Matsuo,1991; Grayson, 1999; Avni, 2009; Pannaci, 2021). These protocols include the use of devices—stents and nasal retractors—which must be placed at the same time as the intraoral plate. For the manufacture of stents or retractors, an impression of the baby's nasal region is also required. Both for the preparation and delivery of nasal devices and for their manufacture, qualified personnel must be employed.

To develop skills, learn new techniques or demonstrate new products in the field of presurgical orthopedic treatments for newborn patients with CLP, it is beneficial for the student or practitioner to have the opportunity to perform all the necessary procedures on a repeated basis. However, there are not always enough patients to provide a steady supply of opportunities. Furthermore, each patient tends to have varying and unique problems, which does not allow equal and consistent opportunities for trainees to practice. In addition, impression taking in vulnerable patients can be potentially life-threatening, with the risk of airway obstruction and aspiration of impression material (Weise et al., 2021).

Specialist training is a sensitive issue, as they need to work with babies who are only a few days old, in a delicate area such as the mouth, which is directly linked to the airways. It should be considered that this malformation links both the oral and nasal cavities, so anything entering the mouth, including food, moves up to the nasal cavity. In this sense, the rehabilitation of vital functions of the CLP newborn, such as breathing and feeding, depend on professional expertise. Skill and experience in performing medical procedures is acquired by repetition.

Training new staff and professionals in this field involves a learning curve that depends on the expertise in performing the maneuver. Such experience is acquired by repeating and improving the process over and over again. Therefore, the risk of performing procedures by untrained personnel decreases the chances of repetition with real newborn patients, considerably lengthening the learning curve of the practitioner.

Due to the prevalence of this condition (CLP is the most common congenital craniofacial malformation in humans) and the respiratory and feeding complications that patients with CLP present at birth, adequate training of personnel is imperative to perform high risk maneuvers, such as taking intraoral impressions, intraoral scanning, as well as the manufacture/placement of intraoral and nasal devices for presurgical treatments.

In addition, the treatment protocol for which the student and practitioner need training may call for a series of procedures or steps. For example, the protocol may include regular impression taking, manufacture of intraoral and nasal device, each of which may require waiting time or preparation time between each procedure. Accordingly, a treatment protocol may span over six months or more, thereby making it difficult to experience and fully appreciate the entire procedure. Therefore, it would be beneficial to perform lengthy protocols in a simulated and accelerated manner (Cox 2015: Sharma et al., 2017).

The present invention relates to a mannequin simulator with cleft lip and palate (CLP) deformity for didactic purposes to learn how to perform pre-surgical treatments and surgery procedures for CLP patients aimed at dentist-related professionals and university students, but also for parents and caregivers. The mannequin provides a highly accurate representation of the whole body and the intra-oral and facial anatomical features of a newborn with CLP deformity turn training into a highly realistic experience, significantly shortening the learning curve of the trainees. All the maneuvers commonly applied by current preoperative treatment protocols for real patients with CLP can be performed on the mannequin. This pre-surgical therapy aims to help the patient to be fed properly and also to improve skeletal relationships and increase the chances of success of the surgery.

Once the pre-surgical treatment protocol has been chosen, each step can be performed on the mannequin simulator. These steps include: clinical evaluation of the oral cavity, intraoral and nasal impression taking and manufacture, placement and removal of the intraoral and nasal devices, which can be practiced directly on the simulator mannequin. The invention described here allows performing as many repetitions of the maneuvers as needed, without limit, thus drastically cutting down the learning curve.

### SUMMARY

The invention involves a physical mannequin simulator of a complete newborn baby with facial and intraoral features of the CLP malformation. The Advanced Training System Mannequin Simulators with cleft lip and palate (AMACS) recreates all the anatomic parts of a real neonate human body including the head, scalp, face, mouth, neck, trunk and extremities in detail.

The AMACS's design is based on a three-dimensional study of the head of a newborn human with a cleft lip and palate. A 3-D image of the whole head is obtained by digital techniques such as computer tomography (CT) scan or photogrammetry. The prototype replicates the particular anatomic features of the entire head and face, as well as the dimensions and proportions of the intraoral and nasal anatomy of the CLP human deformity. The following structures are faithfully reproduced: nose, columella, nostrils, lips, tongue, frenulum, jaw, maxillary segments, alveolar and palatal gap, hemi-uvulae, cheeks, bottom of the vestibule, mucous membranes septum and premaxila.

In one embodiment, the AMACS is made of polymer-based materials, which make it a flexible, durable, resistant and repairable product. The surface of the prototype resembles the texture of the skin. The body design is based on a distribution of the mass and weight of the head, trunk and extremities, which generates a sense of realism when handling or carrying the mannequin simulator. The entire body, the face and specifically the oral and nasal cavities are characterized using realistic painting techniques. As this invention involves a combination of anatomical details and peculiarities in terms of dimension, mass, texture and color, it recreates an extremely realistic prototype, very similar to a newborn with CLP, thus generating a high-level and faithful training experience.

The first step of preoperative treatment for CLP patients is to take an intraoral impression. These procedures from new born patients must be taken by properly trained specialists because it involves risks such as: blocking mechanically the baby's upper respiratory tract while leaving impression material inside the gap of the alveolus or the palate or even blocking the upper airway of the patient. To develop the skills required for these maneuvers, the training of professionals is based on performing the procedures repeatedly. Unfortunately, the high risks related to these procedures, make it impossible to carry out repeated maneuvers on newborn patients.

Another useful aspect of the AMACS is that it is applicable to the training of parents and caregivers, both for daily oral hygiene care and for the management of oral and nasal devices of CLP newborns and infants.

The use of simulators such as those described in this document make it possible to train specialists in conditions that are similar to those of real life, with the benefit of eliminating the risk while the procedure is performed and of being able to repeat it ad infinitum. This represents a big step forward and a significant improvement for all those involved in the treatment of the CLP patient.

The materials, methods, components, features, embodiments, examples, and drawings disclosed herein are illustrative only and not intended to be limiting.

### DESCRIPTION OF DRAWINGS AND PHOTOS

The invention is best understood from the following detailed description when read in connection with the drawings disclosed herein, with similar elements having the same reference numbers. The various features of the drawings may not be to scale and may be arbitrarily expanded or reduced for clarity. Included in the drawings are the following figures:

FIG. 1 is a whole-body frontal view of the Advanced Training System Mannequin Simulators with cleft lip and palate (AMACS), according to one embodiment of the present invention, showing a unilateral deformation of the right side.

FIG. 2 is a whole-body right lateral view (FIG. 2A), and a whole-body back view (FIG. 2B) of the AMACS of FIG. 1.

FIG. 3 is an enlarged frontal view of the head of the mannequin simulator AMACS of FIG. 1. Shows unilateral right cleft lip and palate deformity and details of the lips and tongue (FIG. 3A), and shows a perspective view of the face and intraoral cavity (FIG. 3B).

FIG. 4 is an enlarged and detailed intraoral view of the maxillary segments and contour of the maxilla deformity of the mannequin simulator AMACS with unilateral right cleft lip and palate. The details of the central and lateral frenulum are observed, in addition, the palatal shelves, the alveolar crests of the palatal segments and the hemi uvulae are also noted.

FIG. 5 is a frontal view of the skull of the AMACS's head showing the hair, eyebrows, open eyes and eyelashes according to one embodiment of the present invention (FIG. 5A), and a back view of the body and head of the AMACS showing the back of the neck and the arrangement of the hair on the skull (FIG. 5B).

FIG. 6 is an enlarged view of the AMACS′S feet showing the details of the nails of FIG. 1 (FIG. 6A), and an enlarged frontal view of the trunk showing details of nipples and nave (FIG. 6B).

FIG. 7 shows a black and white whole-body front view photo of the prototype of the mannequin simulator AMACS with unilateral right cleft lip and palate.

FIG. 8 is a black and white frontal perspective view photo of prototype of the mannequin simulator AMACS's head with unilateral right cleft lip and palate deformity, showing open mouth, and also the alveolar and palatal gap (FIG. 8A), and a black and white intraoral view photo of the maxillary segments and contour of the maxilla deformity of the unilateral right cleft lip and palate mannequin prototype. The details of the central and lateral frenulum are observed, in addition, the palatal shelves, the bottom of vestibule, the alveolar crests of the palatal segments and the hemi uvulae are also noted (FIG. 8B).

FIG. 9 shows a black and white frontal view photo of prototype of the mannequin simulator AMACS's head with bilateral cleft lip and palate deformity (FIG. 9A), and a black and white intraoral view of the maxillary segments and contour of the maxilla deformity of the bilateral cleft lip and palate mannequin prototype. The details of the central and lateral frenulum are observed, in addition, the palatal shelves, the bottom of vestibule, the alveolar crests of the palatal segments and the hemi uvulae are also noted (FIG. 9B).

FIG. 10 shows a black and white frontal view photo of prototype of the mannequin simulator AMACS's head with bilateral cleft lip and palate, with the appearance of a Down syndromic newborn human.

FIG. 11 shows the process of design of the AMACS head with details of the intraoral space and maxillofacial region of a human cleft lip and palate newborn head, based on a computed tomography (CT) scan method (FIG. 11A), and on a photogrammetry method (FIG. 11B).

FIG. 12 is a black and white frontal view photo of the process of manufacture of the head of the AMACS prototype with right unilateral cleft lip and palate, based on the 3-D print method (FIG. 12A), and on injection of polymer-based material method (FIG. 12B).

### DEFINITIONS

To facilitate understanding of the invention, a number of terms are defined herein.

“Cleft lip and palate” means birth defects that occur when a baby's lip, nose or mouth do not form properly during pregnancy. Cleft lip and cleft palate are among the most common birth defects in humans and affects the structures of the superior lip, nose and palate. In the most common forms, the gap can be located on the right or left side of the upper lip and the cleft space can measure from 1 to 9 mm. The palate could also be involved and the gap could be 4 to 15 mm wide. The nose anatomy is also affected. There are different cleft types of CLP in humans, they are: A) Cleft lip and palate unilateral (right or left), B) Cleft lip and palate bilateral, C) Cleft lip and palate medial and D) isolated cleft palate. When a child is born with cleft lip and palate, the oral cavity and the nasal cavity are completely connected. The vital functions of breathing and feeding are deeply impaired and the life of the newborn is in risk.

“CLP” is an acronym for “Cleft lip and palate”. It is also called as lip and palate deformity.

“Cleft” means fissure, gap, that is not united.

“Deformity” means that has not been formed correctly. When referring to the human, “deformity” means malformation.

“Alveolar gap” means the separation between the maxillary segments at the level closest to the lips. It is also called as alveolar fissure.

“Maxillary segments” means the portions of bone that form the maxilla. In patients with unilateral CLP, the palate is divided into two maxillary segments. The one on the affected side is always smaller.

“Palatal shelves” means the two portions of the palate. In mammals the palatal shelves are united in the middle raphe (midline). These structures are lined with mucosa. In CLP cases the palatal shelves are separated by a gap.

“Alveolar ridges” means the raised thickened border of the maxilla or the lower jaw that contains the tooth sockets.

“Complete CLP” means when the entire vertical thickness of the lip, alveolus and palate is separated.

“Incomplete CLP” means when any of the structures of the lip, alveolus, or palate may be partially close, commonly the lip. These incomplete clefts do not involve the complete thickness of the lip, alveolus and or palate.

“Lip” means either of the two fleshy folds that surround the mouth in mammals. In the newborn human, its integrity is essential for adequate feeding and breathing.

“Palate” means the roof of the mouth.

“Mannequin” means a model with human form.

“AMACS” is an acronym for “The Advanced Training System Mannequin Simulators with cleft lip and palate”.

“Intraoral” means within the mouth.

“Intraoral impressions” means a negative imprint of hard and soft tissues in the mouth from which a positive reproduction can be formed.

“Intraoral device” means an appliance or prothesis to be worn within the oral cavity, and that has been designed to perform a specific task.

“Intraoral appliance” means a device or prothesis.

“Nasal stent” means a device to place into the nostril, and that has been designed to mold the nasal cartilage deformed.

“Nasal Retractor” means a manufactured device that is placed inside the affected nostril in infants and neonates with CLP to mold the deformed cartilage before surgery.

“Pre-surgical treatment protocols” means all established and recognized treatments to prepare the patient before a planned surgery. They are also called “Preoperative treatments”.

“Pre-surgical orthopedic treatments protocols” means all procedures performed on the cleft lip patient prior to planned surgery. The goal of orthopedic treatment is to reduce the gap by improving the relationships between the maxillary segments. Another important objective of orthopedic treatment in patients with CLP is to rehabilitate affected vital functions such as breathing and feeding.

“Skeletal relationships” means the proximity and position of the bones, one with another.

“Nasal cartilages” means structures within the nose that provide form and support to the nasal cavity. The nasal cartilages are made up of a flexible material called hyaline cartilage.

“Columella” means the tissue which connects the nasal tip to the nasal base and separates the nares. The columella has a major esthetic and structural role at the inferior margin of the nasal septum, and its absence has both functional and esthetic consequences.

“Nostrils” means either of two external openings of the nasal cavity in vertebrates that admit air to the lungs and smells to the olfactory nerves.

“Frenulum” means is a piece of soft tissue that runs in a thin line between the lips and gums. It's present on the top and bottom of the mouth. There's also a frenum that stretches along the underside of the tongue and connects to the bottom of the mouth behind the teeth.

“Hemi-uvulae” means the uvula is divided into two equal parts. The uvula is the soft flap of tissue that hangs down at the back of the mouth (at the edge of the soft palate).

“Bottom of the vestibule” means a small slit-like space between the teeth and inner mucosal lining of the lips and cheeks. It would also be correct to call it oral vestibule.

“Mucous membranes” means the moist, inner lining of some organs and body cavities (such as the nose, mouth, lungs, and stomach).

“Septum” means a piece of cartilage that separates two chambers, such as the one between the nostrils.

“Palatal rugae” means a series of transverse ridges on the anterior part of the palatal mucosa. These rugae are present on each side of the median palatal raphe and behind the incisive papillae. Palatal rugae are part of the anatomy of the palate.

“Premaxilla” means one of a pair of small cranial bones at the tip of the upper jaw. Contains the 4 upper incisor teeth. In humans, they are fused with the maxilla.

“Polymer-based materials” means any of a class of natural or synthetic substances composed of very large molecules, called macromolecules, that are multiples of simpler chemical units called monomers. Polymers make up many of the materials of living organisms and are the basis for many minerals and man-made materials.

“Down syndrome” means a genetic disorder whereby a person has three copies of chromosome 21 instead of two. Patients Down syndrome often have a characteristic facial appearance that includes a flattened appearance to the face, outside corners of the eyes that point upward (up-slanting palpebral fissures), small ears, a short neck, and a tongue that tends to stick out of the mouth.

“Photogrammetry” means Photogrammetry is a method of obtaining reliable information about physical objects through the process of recording, measuring, and interpreting photographic images and image patterns.

### DETAILED DESCRIPTION

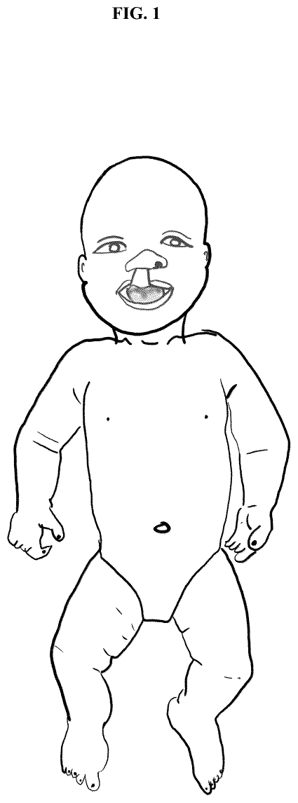

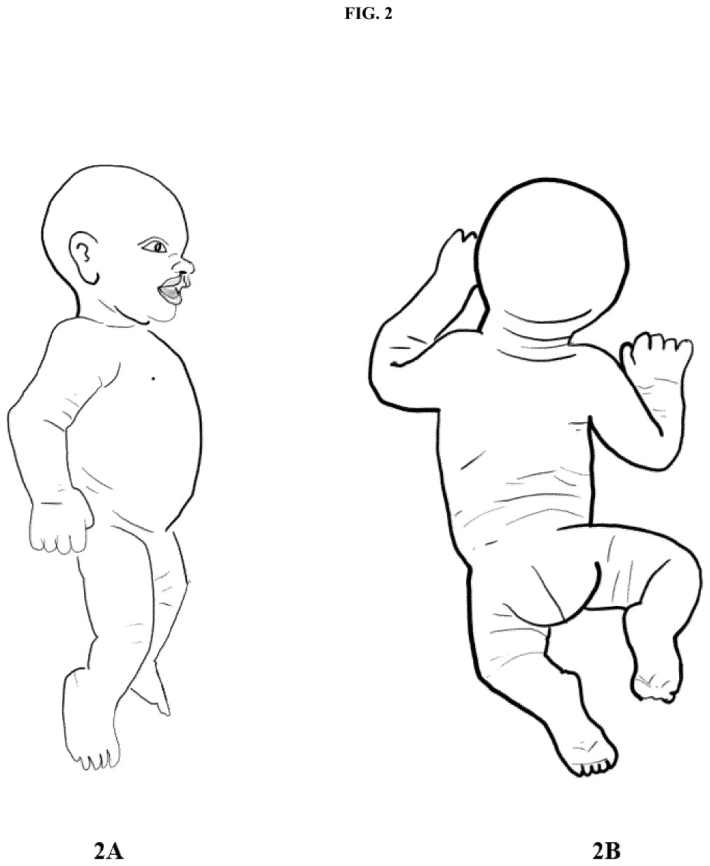

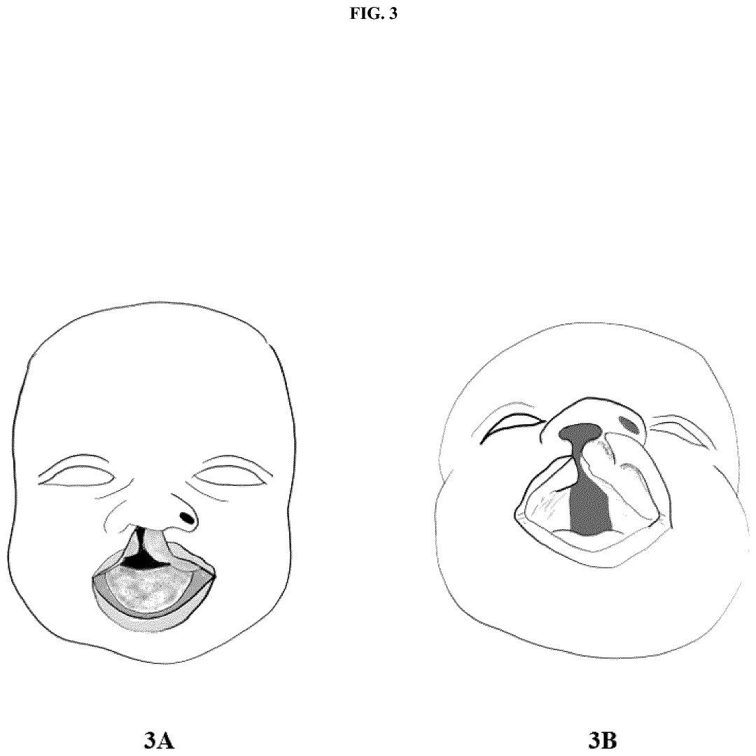

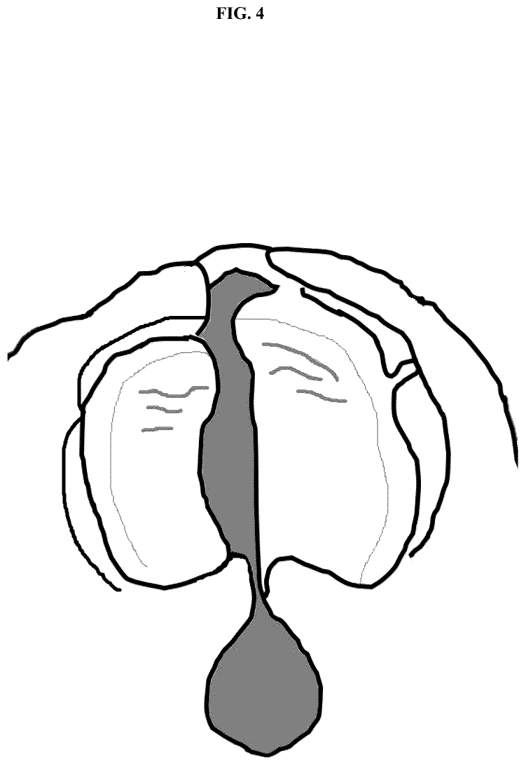

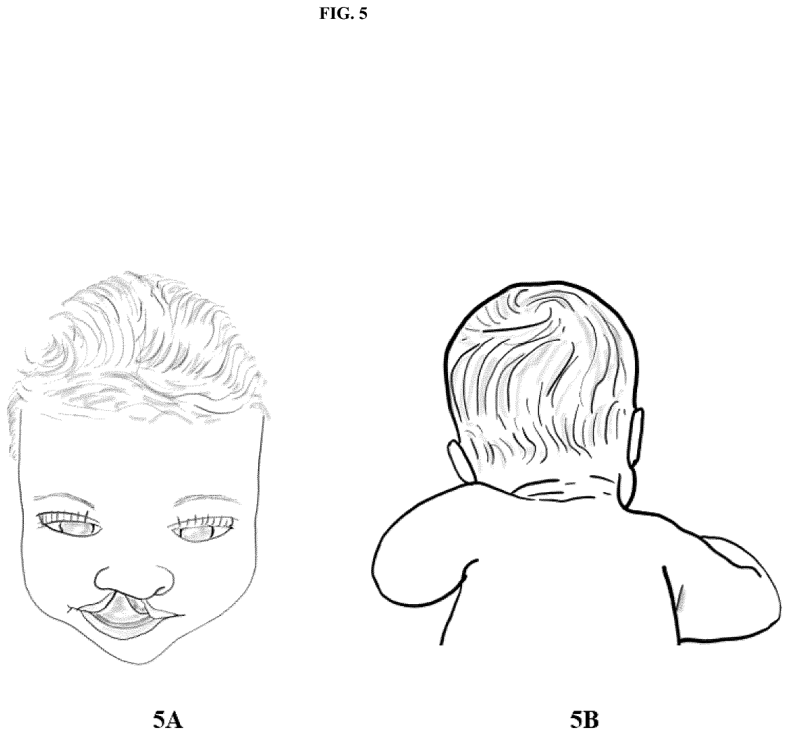

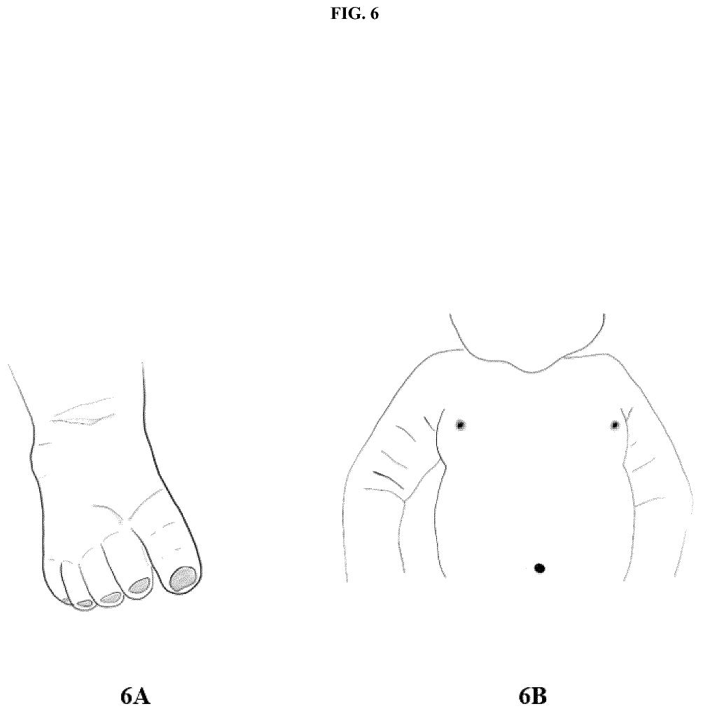

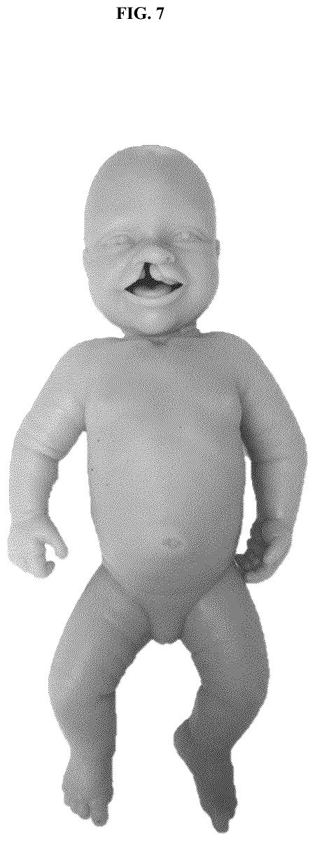

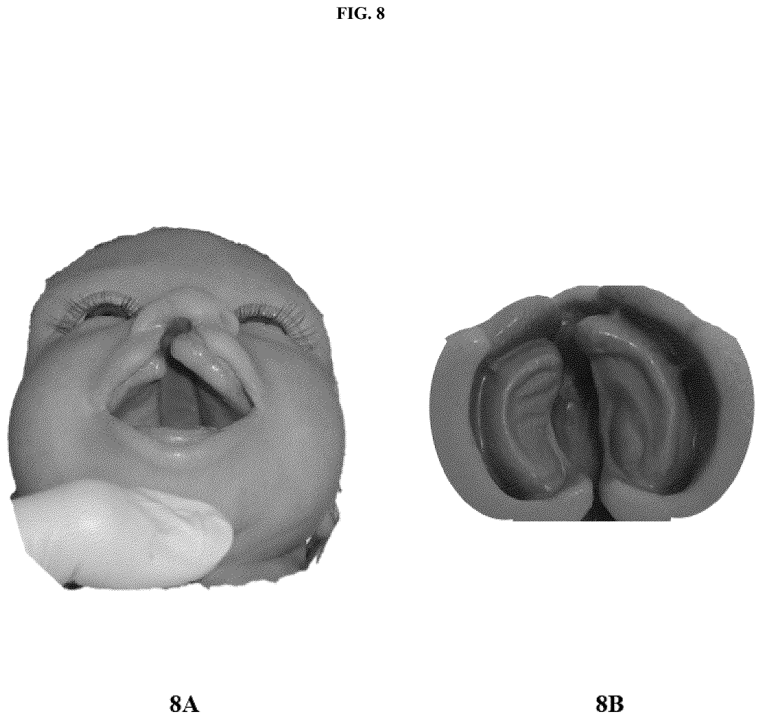

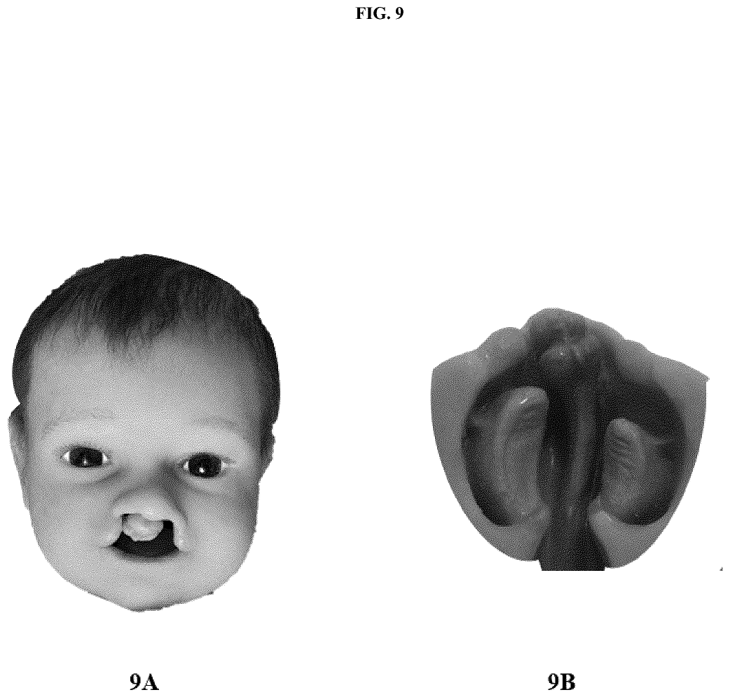

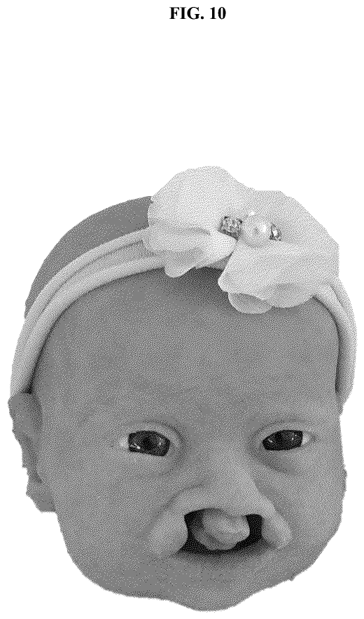

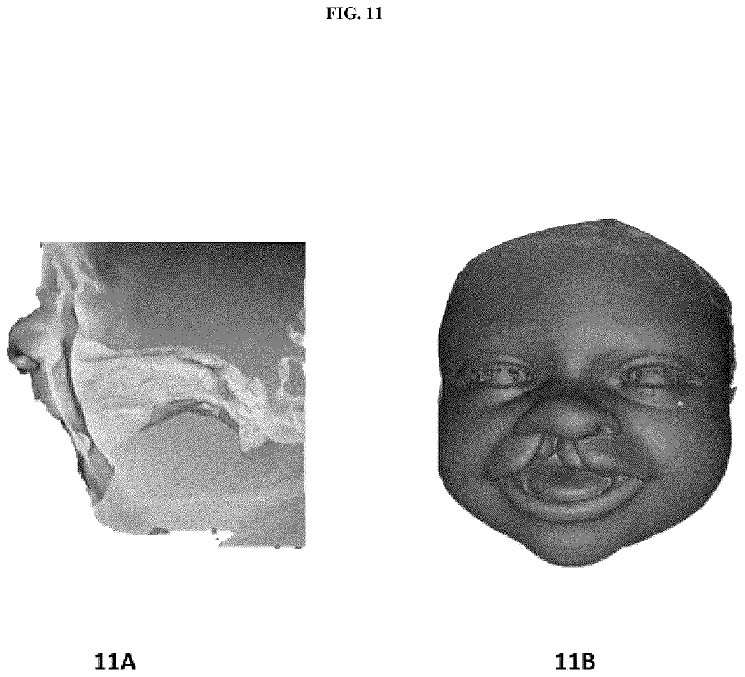

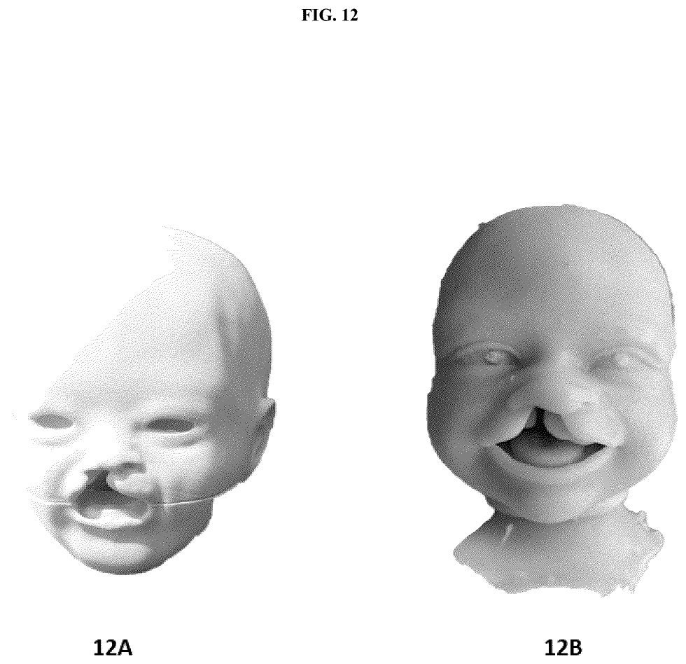

This disclosure describes a new Advanced Training System Mannequin Simulators of a complete newborn baby with facial and intraoral features of the CLP malformation, AMACS, which modifies the current pre-surgical CLP procedures and is particularly applicable to the training of personnel and caregivers for the care of newborns and infants with this deformity, with reference to FIGS. 1-12.

The design of the AMACS follows several steps. First, a computer tomography (CT) scan of a human head is taken to obtain a three-dimensional (3-D) image of the whole head of a CLP newborn, and specifically of the oral and maxillofacial region. The CT scan provides multiple sectional images of the baby's head taken in small slices. The sectional images are then converted to a recognizable digital format by 3-D modeling and animation software. The 3-D modeling software is used to build a clay model of the CLP newborn's oral and maxillofacial region using the converted CT images. In addition, extraoral and intraoral photographs of real newborn CLP patients are taken as reference for head modeling and cavity dimensions.

Next, using the 3-D model, a single negative clay mold is created. Each 3-D clay model can be modified so that CT scans of a single newborn patient with CLP can be used to fabricate the different types of cleft lip and palate (unilateral right, unilateral left, medial and bilateral). Using a known molding process, such as injection molding, patterns of each layer and component are produced from individual molds.

Patterns can be formed using polymer-based materials. Each model is formed by a single homogeneous layer of material. Subsequently, each model is injected with a variety of polymers to give the final finish to the volume of the lips, uvulae and maxillary segments. The materials are similar to the real texture of the layers of human skin, scalp, nails, tongue and mucosa. The final appearance is a surface layer that is soft to the touch, slightly yielding with gentle pressure or tension. Despite its flexible, soft and malleable state, the model is able to maintain its shape thanks to the resistance of the polymer-based used.

The body and head are made of polymer-based materials and the two parts are assembled at the neck. In one embodiment used as current prototype the length, from head to toe, is 48 cm and the weight is 2.700 gms.; the dimensions and weight can be changed to create new prototypes when required. The quality of the polymer-based materials used to build the mannequin makes it a reusable product, durable and, if necessary, each part can be repairable. Full body surface texture is treated using hyper-realistic techniques making it similar to human skin. Although the mannequin is articulated, the external surface of the whole body is completely smooth and uniform.

The body is painted in its entirety, the techniques used are brush and airbrush to give it the chosen tone. The color of the mannequin surface can be chosen among white, yellow and brown, simulating the skin tone of the different ethnic groups. It is then textured for the final finish to make it feel like real skin. Then, the areas corresponding to the superficial anatomical path of the veins of a human infant are retouched. The characterization of the details of the skin, such as the route of the veins, the relief of the clavicles, ribs, nipples, elbows and knees, are completed with different painting techniques. A different characterization is given to the fingernails and toenails to make them look shiny.

The head, face and intraoral cleft lip and palate features, dimensions and proportions of this invention are reproduced with a 3-D tomography from a real newborn with CLP deformity. The final prototype of the mannequin has a surface made by texturing and matting the polymer-based material, which makes the surface texture similar to that of human skin. To accentuate the realism of the prototype, hair and eyebrows of natural hair are grafted, so it is possible to choose their type and tone. The Mannequin simulator can have its eyes closed or open. In case of open eyes, the color can be chosen among the following options: light blue, dark blue, green, brown or black. The eyelashes are grafted; however, they could be painted if required.

The hair is grafted onto the surface of the scalp area. This is done by strands following a pattern that simulates the swirls of hair that humans have at birth. The hair used is natural human hair, and it can be chosen among blonde, brown and black. Then, a stylish haircut is chosen. The final result of the hairstyle is fixed with hairspray.

The facial, nasal and intraoral features of the AMACS's head can be produced in various options in according to the different types of CLP deformity, just as it occurs naturally in humans: A) Cleft lip and palate unilateral (right or left), B) Cleft lip and palate bilateral, C) Cleft lip and palate medial and D) isolated cleft palate. In this way, a complete mannequin (AMACS) is reproduced for each type of CLP deformity. In addition, the lower jaw has a normal appearance: shape and dimensions without deformities. Intraorally, the lower jaw of the mannequin simulator includes the alveolar ridge, vestibule and the tongue. Characterization of the tongue includes the pinky color and rough texture that resemble the anatomy of the taste buds present on a human epithelium of the tongue tissue.

The lips of the mannequin are flexible and exploration of the intraoral vestibule as would occur in a real oral examination in the human newborn is possible. In addition to the anatomical details of the malformation, the mannequin allows the opening of the mouth; it has the characteristic of articulating the lower jaw so that the oral cavity can be explored including the tongue, inner portion of the cheeks, frenulum, maxillary segments and the nasal cavity. The mannequin has the ability to open its mouth and the external surface of the face and cheeks are completely smooth and uniform. The areas of the lips, the intraoral mucosa of the cheeks and maxillary segments are shiny, smooth and pale pink in color, as in humans. The lips of the mannequin are painted with pink tones and with an airbrush technique, to simulate the color of the lips of a human infant. The painting of the lips, intraoral and intranasal cavity is done in several consecutive steps in order to give the different shades of the mucosa of the different regions. The surface finish of the lips is smooth and slightly shiny in appearance to simulate that they are moist, as it would be in a real human.

The tongue is painted with pink tones that are darker than the tone of the lips, and it is textured to imitate the rough appearance that the taste buds give, simulating the tongue of a newborn human.

Intraorally, the shape of the maxillary segments is sculpted to resemble characteristic anatomical zones, as occur in a newborn with CLP deformity, such as the palatal rugae, the premaxilla and the alveolar ridges of the segments. In addition, the vestibule fundus and the front and lateral frenulum are sculpted and detailed as in a newborn patient with CLP deformity. Colors and textures of the maxillary segments, alveolar ridge, vestibule bottom and palate resemble those characteristics that are observed in CLP newborn.

The mannequin palatal shelves are separated by a gap ranging from 5 to 10 mm, recreating the features of the CLP deformity in humans. In addition, the posterior part of the cleft palate ends in two hemi uvulae, just as in reality when the palate is cleft.

The maxillary segments of the mannequin's mouth can be approximated or separated manually or by the action of any device used for pre-surgical treatments of CLP cases, simulating the movement of the maxillary segments, as occurs in real life.

The nostrils of the mannequin are flexible and allow the insertion of intranasal devices. The nasal mucosa zone is smooth and magenta in color, as in humans. The material of the nostrils and alar cartilage expands as it would in a CLP patient with nasal deformity when an intranasal device is inserted. In addition, tapes and plasters can be placed on the surface of the mannequin as a complement to intranasal and intraoral devices, as happens in preoperative treatments protocols.

The eyes used for the mannequin are prefabricated. After choosing the color, which can be green, blue, brown or black, they are introduced into the orbital cavity.

The eyebrows and eyelashes of the mannequin are grafted following the same technique used to place the hair on the head. The hair used is natural human hair and the color the same as the chosen hair.

Due to the flexibility and resistance properties of the mannequin material, surgical procedures can be simulated, such as cutting the surface with a scalpel or scissors, approaching the edges and suturing. These can be carried out using the same instruments as for surgical purposes. In addition, tapes and acrylic appliances can also be placed on the surface of the mannequin as in pre and post operative treatment of CLP patients.

The use of this invention comprises:
A) to train specialists performing intraoral impressions on patients with CLP, in conditions similar to those of real life by eliminating the risk of such maneuvers and the need to disturb a real newborn patient for the training procedure.
B) to shorten the learning curve of those who are being trained, since the procedures can be repeated over and over again.
C) to teach and educate parents and caregivers on how to clean and feed the child properly without risk of choking.
D) to train professionals, parents and caregivers of these patients in how to clean, place and remove the intraoral appliances and nasal devices indicated by medical protocols for treatment compliance.
E) to teach students from dental and related schools to recognize and detect the different types of cleft lip and palate, and so refer them to a specialist.
F) to help with the planning and manufacturing of intraoral devices, nasal conformers and extraoral supports currently included in clinical protocols in compliance with required preoperative treatments.

REFERENCES

| | |
|---|---|
| U.S. Pat. No. | 8,282,635 |
| U.S. Pat. No. | 10,672,297 |
| U.S. Pat. No. | 11,288,982 |
| U.S. Pat. No. | 11,273,011 |
| United States Patent Application | 20200316850 |
| United States Patent Application | 20200410898 |
| United States Patent Application | 20170337848 |
| United States Patent Application | 20140272868A1 |

1. Alzain I, Batwa W, Cash A, Murshid Z A. Presurgical cleft lip and palate orthopedics: an overview. Clin Cosmet Investig Dent. 2017 May 31; 9:53-59, doi: 10.2147/CCIDE.S129598. PMID: 28615974; PMCID: PMC5459959.
2. Avni A. The nasal alar elevator: A new device that may reduce the need for primary operation of the nose in patients with cleft lip. Scand J Plast Reconstr Surg Hand Surg, 2009; 43: 71_74.
3. Brijesh M. Presurgical nasoalveolar molding for correction of cleft lip nasal deformity: experience from northern India. Plast Surg J. 2010; 10: 443-456.
4. Cox T, Seymour N, Stefanidis D. Moving the Needle: Simulation's Impact on Patient Outcomes. Surg Clin North Am. 2015 Aug;95(4):827-38. doi: 10.1016/j.suc.2015.03.005. Epub 2015 Apr. 22. PMID: 26210974.
5. Erantia E Visser. Feeding difficulties in infants with unrepaired cleft lip and palate and HIV-exposure. Afri Health Sci. 2018;18(4): 1098-1108. https://dx.doi.org/10.4314/ahs.v18i4.31_Department of Speech-Language Pathology and Audiology, Faculty of Humanities, University of Pretoria Private Bag X20, Hatfield 0028.
6. Grabowski R, Kopp H, Stahl F, Gundlach K. Presurgical orthopaedic treatment of newborns with clefts—functional treatment with long-term effects. J Cranio-Maxillofac Surg. 2006; 34:34-44.
7. Grayson B, Brecht L E, Cutting CB (2000): Nasoalveolar Molding in Early Management of Cleft Lip and Palate. Editorial TD. Clinical maxillofacial prosthetics. Quintessence. pp 63_84.
8. Grayson et al. Presurgical Nasoalveolar Molding in Infants with Cleft Lip and Palate. Cleft Palate craniofacial Journal. November 1999.Vol 36:486-98/ N°6.
9. Grayson B, Shetye P and Cutting C (2005): Presurgical Nasoalveolar molding treatment in cleft lip and palate patients. Cleft Journal I, pp4-7.
10. Jacobson B N, Rosenstein S W (1984): Early maxillary orthopedics for the newborn cleft lip and palate patient. An impression and an aplliance. Angle Otho 54, pp 247-263.
11. M. Goyal. Role of obturators and other feeding interventions in patients with cleft lip and palate: a review. Eur Arch Paediatr Dent (European Academy of Paediatric Dentistry) 2014; 15:1-9 DOI 10.1007/s40368-013-0101-0.
12. Mahasneh D, Shoqirat N, Alsaraireh A, Singh C, Thorpe L. From Learning on Mannequins to Practicing on Patients: Nursing Students' First-Time Experience of Clinical Placement in Jordan. SAGE Open Nurs. 2021 Mar 23;7:23779608211004298. doi: 10.1177/23779608211004298. PMID: 33912672; PMCID: PMC8047831.
13. Matsuo K, Hirose T. Preoperative non-surgical over-correction of cleft lip nasal deformity. Br J Plast Surg. 1991; 44: 5-11.
14. Pannaci T. Cleft Dental Treatment and Naso-Alveolar Molding. Global Cleft Care in Low-Resource Settings, Chapter 26. Jordan Swanson and David Low. Abril 2021.
15. Thistlethwaite J E, Davies D, Ekeocha S, Kidd J M, MacDougall C, Matthews P, Purkis J, Clay D. The effectiveness of case-based learning in health professional education. A BEME systematic review: BEME Guide No. 23. Med Teach. 2012;34(6): e421-44. doi: 10.3109/0142159X.2012.680939. PMID: 22578051.
16. Yang S, Stelnicki E J Lee M N (2003): Use of Nasoalveolar Molding Appliance to Direct Growth in Newborn Patient with Complete unilateral Cleft Lip and Palate. Pediatric Dentistry 25(3), pp253-256.
17. Yilmaz H N, Özbilen EÖ, Üstün T. The Prevalence of Cleft Lip and Palate Patients: A Single-Center Experience for 17 Years. Turk J Orthod. 2019 Sep;32(3):139-144. doi: 10.5152/TurkJOrthod.2019.18094. Epub 2019 Sep 1. PMID: 31565688; PMCID: PMC6756567.
18. Weise C, Frank K, Wiechers C, Weise H, Reinert S, Koos B, Xepapadeas A B. Intraoral scanning of neonates and infants with craniofacial disorders: feasibility, scanning duration, and clinical experience. Eur J Orthod. 2021 Sep 17: cjab068. doi: 10.1093/ejo/cjab068. Epub ahead of print. PMID: 34532733.
19. Sharma N, Doherty I, Dong C. Adaptive Learning in Medical Education: The Final Piece of Technology Enhanced Learning? Ulster Med J. 2017 Sep;86(3):198-200. Epub 2017 Sep 12. PMID: 29581634; PMCID: PMC5849979.

What is claimed is:

1. A mannequin simulator of a complete newborn baby with facial and intraoral features of the CLP malformation for training or intervention procedures involving the nose, lips and palate, comprising:
(1) A complete body, trunk and limbs, having as reference the height and the distribution of the mass and weight of a human newborn.
(2) A complete head, skull, face and neck, having as reference the weight, height, facial and intraoral CLP features of a human newborn.
(3) The face, lips, nose, oral and nasal cavities have the actual anatomical dimensions and proportions of a newborn with CLP deformity.
(4) The facial, nasal and intraoral features showing one of the following various options: A) Complete and incomplete right CLP; B) Complete and incomplete left CLP; C) Complete and incomplete bilateral CLP; D) Complete and incomplete medial CLP; and F) Cleft palate.
(5) The arms, legs and neck have a similar mobility to that of a newborn human: while holding creates a realistic feeling the distribution of densities and weights in the body parts, limbs, neck and head.
(6) The lips and cheeks are flexible and expandable similar to that of the human newborn.
(7) The mouth opening is also comparable to that of a newborn.
(8) The maxillary segments, premaxila and palatal shelves of the mannequin's mouth can be approximated and separated manually or by the action of any device (plate or prosthesis).
(9) The nostrils and alar cartilage of the mannequin's nose are flexible and allow for the insertion of intranasal devices.
(10) The lips, nose, oral and nasal cavities are painted with pink tones showing different shades of the mucosa, to simulate the color of these structures of a human infant.
(11) The texture of the tissues in smooth and touch simulates as in the real human layers of skin, scalp, nails, and mucous membranes; soft to the touch, slightly yielding with gentle pressure or tension.
(12) The characterization of the tongue includes the pinky color and rough texture that resembles the anatomy of the taste buds present on a human epithelium of the tongue tissue.
(13) The shape of the maxillary segments resembles the characteristic anatomical of a newborn with CLP deformity with details of the palatal rugae, the alveolar ridges, the premaxilla, the two hemi uvulae, the vestibule fundus, the front and lateral frenulum.
(14) The external surface texture of the whole body is completely smooth and uniform.
(15) Natural human hair is grafted onto eyebrows, eyelashes and the surface of the scalp area.
(16) The eyes can be open or closed and no eyelid mobility.

2. The mannequin simulator of claim 1, where at least one of the characteristics (1.1), (1.5), (1.10), (1.11), (1.12), (1.13), (1.14), (1.15) or (1.16) is absent.

3. The mannequin simulator of claim 1, where the characteristics intraoral, nasal and facial described (1.3) have the appearance of a CLP syndromic newborn human, such as Down Syndrome in human.

4. The mannequin simulator of claim 1, where the natural human hair (1.15) can be painted rather than grafted.

5. The mannequin simulator of claim 1, where in the body sex variants are male, female or undefined.

6. The mannequin simulator of claim 1, where in the component mimicking the skin and interior part of the whole body, head and cavities is made with polymer-based material.

7. The mannequin simulator of claim 1, where in the standard dimensions, appearance or colors adjusted according to human race.

8. The mannequin simulator of claim 1, where painting techniques are used to characterize the color of the external surface of the entire body.

9. The mannequin simulator of claim 1, where the characterization of the skin, the route of the veins, the relief of the clavicles, ribs, nipples, elbows and knees, are made with hyper-realistic painting techniques.

10. The mannequin simulator of claim 1, with an inserted dispositive to reproduce common motion of a newborn.

11. The mannequin simulator of claim 1, with an inserted dispositive to reproduce common sounds of a newborn.

12. The mannequin simulator of claim 1, where at least one of the characteristics (10) or (11) is absent.

13. A process of design of the mannequin simulator of claim 1, comprising at least one of the following:
(1) Head, oral and maxillofacial region design based on a computer tomography (CT) of a newborn head to obtain a three-dimensional (3-D) image of the CLP neonate.
(2) Head, oral and maxillofacial region design based on a photogrammetry of a human head instead of a computer tomography (CT) to obtain a three-dimensional (3-D) image of the CLP newborn.
(3) Head, oral and maxillofacial region design based on a scan technique of a human head instead of a computer tomography (CT) or photogrammetry to obtain a three-dimensional (3-D) image of the CLP newborn.

14. A process of manufacture of the mannequin of claim 1, by assembling various parts.

15. A process of manufacture of any part of the mannequin of claim 1, by at least one of the following methods:
(1) Mold elaboration and injection of polymer-based material
(2) 3-D printing

16. A process of the manufacture of the mannequin simulator of claim 6, where a part of the body can made into fabric instead of polymer-based material.
